(19) United States
(12) Patent Application Publication
(10) Pub. No.: US 2016/0265488 A1
(43) Pub. Date: Sep. 15, 2016

(54) GAS HEAT EXCHANGER, IN PARTICULAR FOR THE EXHAUST GASES OF AN ENGINE

(71) Applicant: VALEO TÉRMICO, S.A., Zaragoza (ES)

(72) Inventors: Benjamin Gracia Lazaro, Le Mesnil Saint Denis (FR); Robén Lalaguna Lacasta, Saint-Denis (FR); Julian Gomez Clerencia, Saint-Denis (FR); Francisco Javier Iguaz Piedrafita, Saint-Denis (FR)

(73) Assignee: Valeo Termico, S.A., Zaragoza (ES)

(21) Appl. No.: 14/917,440

(22) PCT Filed: Sep. 9, 2014
(86) PCT No.: PCT/IB2014/064350

§ 371 Date: May 12, 2016

(30) Foreign Application Priority Data
Sep. 10, 2013 (ES) P201331317

(51) Int. Cl. F02M 26/30; F28F 19/00

(52) U.S. Cl. CPC F02M 26/30; F28F 19/00

(57) ABSTRACT

Gas heat exchanger, in particular for the exhaust gases of an engine, intended for the flow of gases with exchange of heat with a coolant, comprising a gas reservoir (1) having an inlet opening (1a) which can be attached to an end of a casing, an outlet opening (1b) which is connected to a shoulder (2) for connecting to the gas recirculation line, a particle filter (3) for filtering the exhaust gases and associated with the outlet opening (1b) of said gas reservoir (6), and a sealing gasket (4) provided on an outer surface (2a) of the connection shoulder (2). The filter (3) is integral with the gas reservoir (1), thus forming an inseparable single piece suitable for being attached to the casing of the exchanger. The particle filter (3) and the sealing gasket (4) are thus assembled in an optimum manner.

The present invention relates to a gas heat exchanger, in particular for the exhaust gases of an engine.

The invention applies especially to exchangers for recirculating the exhaust gases of an engine (EGRC).

### BACKGROUND OF THE INVENTION

The principal function of EGR exchangers is the exchange of heat between the exhaust gases and the coolant, in order to cool the gases.

Currently, EGR heat exchangers are widely used for diesel applications, in order to reduce emissions, and they are also used in gasoline applications to reduce fuel consumption.

There is a market trend to reduce the size of engines and to use EGR heat exchangers not only in high-pressure (HP) applications but also in low-pressure (LP) applications; both types have an impact on the design of the EGR heat exchangers. Vehicle manufacturers require EGR heat exchangers with higher performance levels and, at the same time, the space available for receiving the exchanger and its components is increasingly small and more difficult to incorporate.

In addition, in many applications, the flow of coolant available for cooling the exhaust gases tends to be smaller, although exchanger performance levels have been increasing.

The current configuration of EGR exchangers on the market corresponds to a metal heat exchanger generally manufactured from stainless steel or aluminum.

Basically, there are two types of EGR heat exchanger: a first type consists in a casing inside which there is a bundle of parallel tubes for the passage of the gases, circulating the coolant via the casing, externally to the tubes, and the second type comprises a series of parallel plates constituting heat exchange surfaces, such that the exhaust gases and the coolant circulate between two plates, in alternate layers, and there may also be fins for improving heat exchange.

In the case of tube bundle heat exchangers, the connection between the tubes and the casing may be of different types. Generally, the tubes are fixed via their ends between two support plates coupled at either end of the casing, both support plates having a plurality of openings for receiving the respective tubes.

Said support plates are in turn affixed to means for connection to the recirculation line, which may consist in a V-connection or, alternately, a peripheral connection shoulder or flange, depending on the design of the recirculation line onto which the exchanger is fitted. The peripheral shoulder may be assembled together with a gas reservoir, such that the gas reservoir is an intermediate piece between the casing and the shoulder or, alternatively, the shoulder may be assembled directly on the casing.

In both types of EGR exchanges the majority of the components thereof are metallic, with the result that they are assembled by mechanical means and then welded in a furnace or welded using arc or laser welding in order to ensure the adequate sealing required for this application.

In certain EGR exchangers, principally in low-pressure (LP) applications, cleaning requirements are stringent and therefore the use of a particle filter incorporated into the exhaust line is increasingly required. Said filter is generally an autonomous component, although it may be partly integral with the EGR exchanger.

Patent EP2273095 relates to a heat exchanger that includes a fluid filter integrated into said exchanger, which includes a filter area extending from a planar surface, This filter is configured as a gasket and is assembled between the connection flange and the gas reservoir by means of screw-fit elements.

Patent EP2134351 relates to a heat exchanger that includes a particle filter for filtering exhaust gases that is structurally integrated inside the gas inlet tube of the heat exchanger.

Patent FR2938051 relates to a heat exchanger that includes a filter housed in a position selected such that the filter is arranged close to an end side of the tube bundle.

Nevertheless, these filters present the drawback that they require a complex, slow assembly process since they use additional gaskets and fastening using screw-fit elements. In addition, their volume increases the dimensions of the exchanger, with the consequent problems of mounting in the engine compartment.

Spanish patent application No. 201230270, from the same holder as the present application, describes a heat exchanger that comprises a gas reservoir provided with an inlet opening that can be attached to one end of the casing and an outlet opening connected to the gas recirculation line, and a particle filter connected to the inlet opening of the gas reservoir, preferably by means of welding.

Also known are heat exchangers that comprise a gas reservoir and a connection shoulder that are incorporated to form a single piece, such that the end of the gas reservoir can be attached to the gas outlet from the casing, and a particle filter coupled internally in relation to the connection shoulder.

This type of filter comprises a screen of concave configuration in the manner of a tray in order to increase the filtering area and a planar peripheral flange provided for connecting to a recess made in the connection shoulder in such a manner that the flange of the filter does not extend from the outer surface of said connection shoulder. Similarly, use is made of a sealing gasket arranged on the outer surface of the connection shoulder, covering the area of connection with said filter.

The use of said recess for receiving the flange of the filter involves a reduction in the outer surface of the connection shoulder, and therefore larger sealing gaskets are required. As a consequence, it is necessary for the outer surface of said connection shoulder to have sufficient space to receive the sealing gasket.

Nevertheless, connection shoulders have dimensions that are limited as a function of the vehicle manufacturers requirements, and therefore it may be that the diameter of the sealing gasket extends in part relative to the outer surface of said connection shoulder, with the consequent problem of gas leakage.

### DESCRIPTION OF THE INVENTION

The aim of the gas heat exchanger, in particular for the exhaust gases of an engine, of the present invention is to resolve the drawbacks of exchangers known in the prior art, providing optimized assembly of the particle filter and the respective sealing gasket.

The gas heat exchanger, in particular for the exhaust gases of an engine, that is the subject matter of the present invention, intended for the flow of gases with exchange of heat with a coolant, is of the type comprising a gas reservoir that includes an inlet opening that can be attached to one end of a casing and an outlet opening connected to a shoulder for connection with the gas recirculation line, a particle filter for filtering the exhaust gases, which is associated with the outlet opening of said gas reservoir, and a sealing gasket arranged on an exterior surface of the connection shoulder, and is characterized in that the filter is integral with the gas reservoir, forming an inseparable single piece capable of being attached to the casing of the exchanger.

Thus, a filter totally integral with the gas reservoir forming a single piece is achieved, thereby facilitating the assembly thereof with she casing of the exchanger.

Similarly, by virtue of the fact that the filter is attached to the gas reservoir and not to a recess made in the outer surface of the connection shoulder, as was the case of filters known in the prior art, a connection shoulder is obtained with a sufficiently large outer surface to accommodate a conventional sealing gasket, without the latter extending from the perimeter thereof, since the outer surface is maintained complete and requires no recess.

Furthermore, it is possible to use a conventional connection shoulder, since there is no need to make any recess, and therefore the production cost is likewise reduced.

Advantageously, the filter is attached between the gas reservoir and the connection shoulder. In this way, the gas reservoir and the connection shoulder are autonomous pieces, which simplifies the production process, contrary to that which occurs in the prior art, wherein the gas reservoir and the connection shoulder are integral, forming a single piece that can be attached to the casing and with the filter connected to a peripheral shoulder recess.

Preferably, the gas reservoir is produced by means of stamping. Therefore, it is possible to use a simpler, more economical gas reservoir.

Preferably, the filter is connected between the gas reservoir and the connection shoulder by means of welding in a furnace. This results in a simpler, more efficient fastening of the filter.

According to one embodiment of the invention, the filter comprises a screen of concave configuration in the manner of a tray, with a planar perimeter flange provided for the connection thereof between the gas reservoir and the connection shoulder.

The configuration in the manner of a concave screen makes it possible to increase the filtering surface and, furthermore, the planar surface of the perimeter flange facilitates the fastening of the filter by means of welding, without the need for intermediate pieces or screw-fit elements.

Advantageously, the connection shoulder comprises a recess made in the surface thereof that faces the gas reservoir, provided to receive the perimeter flange of the filter for the mutual connection thereof. This guarantees permanent, robust fastening by welding of the filter between the gas reservoir and the connection shoulder.

### BRIEF DESCRIPTION OF THE DRAWINGS

With a view to facilitating the description as provided above, drawings are attached which, schematically and solely by way of non-limiting example, show a practical embodiment of the gas heat exchanger, in particular for the exhaust gases of an engine, of the invention, wherein:

FIG. 1 is a perspective view of the assembly formed by a gas reservoir attached to a connection shoulder, which are integrated as a single piece, with a particle filter and a sealing gasket;

FIG. 2 is a transverse section of the assembly shown in FIG. 1;

FIG. 3 is a perspective, expanded view of the assembly formed by a filter attached between a gas reservoir and a connection shoulder, and with a sealing gasket, according to the present invention; and

FIG. 4 is a transverse section of the assembly shown in FIG. 3.

### DESCRIPTION OF A PREFERRED EMBODIMENT

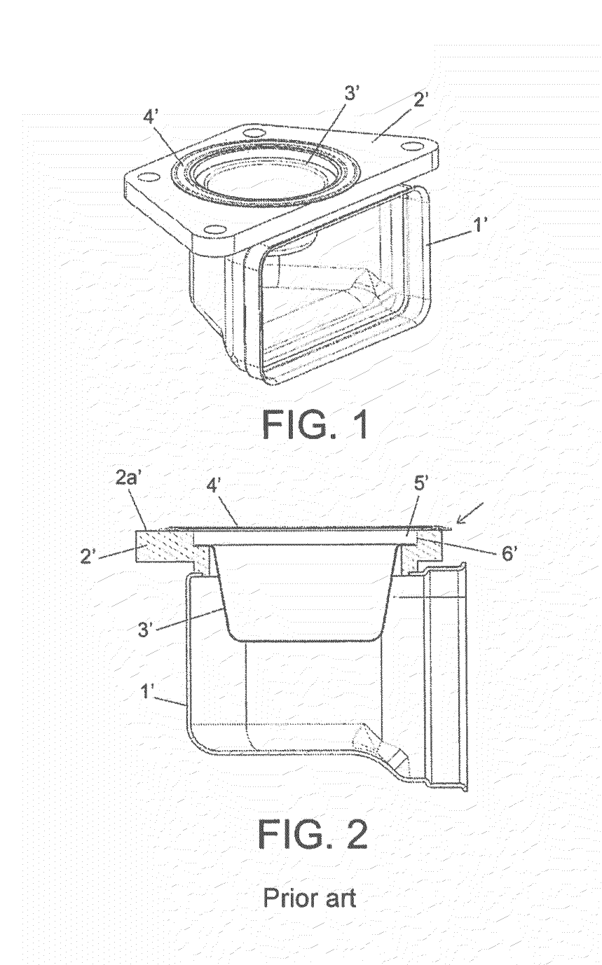

FIGS. 1 and 2 show an assembly formed by a gas reservoir 1′ attached to a connection shoulder 2′ with the recirculation line, integrated as a single component, which can be attached to the casing (not shown) of a heat exchanger according to the prior art. Also included is a particle filter 3′ attached internally to the connection shoulder 2′.

The filter 3′ comprises a screen of concave configuration in the manner of a tray in order to increase the filtering area and a planar peripheral flange 5′ provided for connecting to a recess 6′ made in the connection shoulder 2′ such that the flange 5′ of the filter 3′ does not extend from the outer surface 2a′ of said connection shoulder. Similarly, use is made of a sealing gasket 4′ arranged on an outer surface 2a′ of the connection shoulder 2′, covering the area of connection with said filter 3′.

The use of said recess 6′ for receiving the flange 5′ of the filter 3′ involves a reduction in the outer surface 2a′ of the connection shoulder 2′, and therefore larger sealing gaskets 4′ are required. As a consequence, it is necessary for the outer surface 2a′ of said connection shoulder 2′ to have sufficient space to receive the sealing gasket 4′.

Nevertheless, the connection shoulders 2′ have dimensions that are limited as e function of the vehicle manufacturer's requirements, and therefore it may be that the diameter of the sealing gasket 4′ extends in part relative to the outer surface 2a′ of said connection shoulder 2′, as may foe seen by the arrow illustrated in FIG. 2, with the consequent problem of gas leakage.

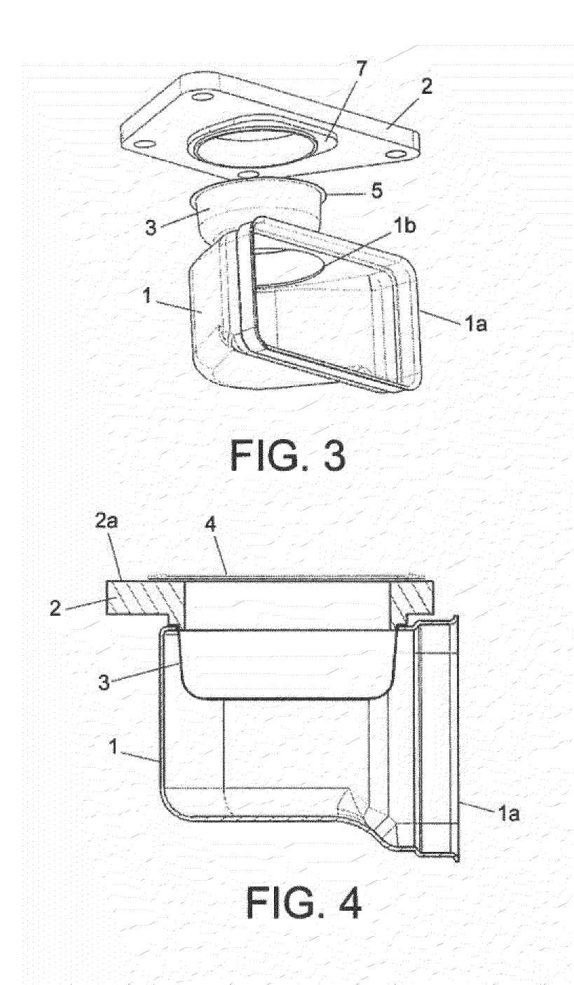

FIGS. 3 and 4 show an assembly formed by a filter 3 coupled between a gas reservoir 1 and a shoulder 2 for connecting to the recirculation line, according to the present invention. The gas reservoir 1 includes an inlet opening 1a that can be attached to one end of the casing (not shown) of a heat exchanger and an outlet opening 1b connected to the connection shoulder 2, a particle filter 3 for filtering the exhaust gases associated with the outlet opening 1b of said gas reservoir 1, and a sealing gasket 4 arranged on an outer surface 2a of the connection shoulder 2.

In this case, the filter 3 is integral with the gas reservoir 1, forming an inseparable single piece capable of being attached to the casing of the exchanger, thereby facilitating the assembly thereof with said casing.

Similarly, by virtue of the fact that the filter 3 is attached to the gas reservoir 1 and not to a recess 6′ made in the outer surface 2a′ of the connection shoulder 2′, as was the case of filters 3′ known in the prior art (see FIGS. 1 and 2), a shoulder connection 2 is obtained with a sufficiently large outer surface to accommodate a conventional sealing gasket 4, without the latter extending from the perimeter thereof, since the outer surface 2a is maintained complete and requires no recess 6′.

Furthermore, it is possible to use a conventional connection shoulder 2, since there is no need to make any recess, and therefore the production cost is likewise reduced.

Furthermore, the filter 3 is attached between the gas reservoir 1 and the connection shoulder 2 in such a manner that said gas reservoir 1 is a piece independent of the connection shoulder 2, In this way, the production process is simplified, unlike the case of the prior art (see FIGS. 1 and 2), wherein the gas reservoir 1′ and the connection shoulder 2′ are integral, forming a single piece that can be attached to the casing and with the filter 3′ connected to a recess 6′ of the peripheral shoulder 2′.

The gas reservoir 1 is produced by means of stamping, and therefore a simpler, more economical gas reservoir may be used.

The filter 3 is connected between the gas reservoir 1 and the connection shoulder 2 by means of welding in a furnace. This results in a simpler, more efficient fastening of the filter.

The filter 3 of the present invention likewise comprises a screen of concave configuration in the manner of a tray, with a planar perimeter flange 5 provided for the connection thereof between the gas reservoir 1 and the connection shoulder 2.

The connection shoulder 2 comprises the recess 7 made in the surface thereof that faces the gas reservoir 1, provided to receive the perimeter flange 5 of the filter 3 for the mutual connection thereof. This guarantees permanent, robust fastening of the filter 3 by welding between the gas reservoir 1 and the connection shoulder 2.

Despite the fact that reference has been made to a specific embodiment of the invention, it is obvious for a person skilled in the art that the gas heat exchanger, in particular for the exhaust gases of an engine, as described, is suitable for numerous variations and modifications and that all the details mentioned may be replaced by other, technically equivalent details without departing from the scope of protection defined by the attached claims.

1. A gas heat exchange for the exhaust gases of an engine, intended for the flow of gases with exchange of heat with a coolant, comprising;
a gas reservoir that includes an inlet opening attached to one end of a casing and an outlet opening connected to a shoulder for connection with the gas recirculation line;
a particle filter for filtering the exhaust gases, which is associated with the outlet opening of said gas reservoir; and
a sealing gasket arranged on an exterior surface of the connection shoulder, wherein
the filter is integral with the gas reservoir, forming an inseparable single piece capable of being attached to the casing of the exchanger.

2. The exchanger as claimed in claim 1, wherein the filter is attached between the gas reservoir and the connection shoulder.

3. The exchanger as claimed in claim 2, wherein the gas reservoir is produced by means of stamping.

4. The exchanger as claimed in claim 2, wherein the filter is connected between the gas reservoir and the connection shoulder by welding in a furnace.

5. The exchanger as claimed in claim 2, wherein the filter comprises a screen of concave configuration in the manner of a tray, with a planar perimeter flange provided for the connection thereof between the gas reservoir and the connection shoulder.

6. The exchanger as claimed in claim 5, wherein the connection shoulder comprises a recess made in the surface thereof that faces the gas reservoir, provided in order to receive the perimeter flange of the filler for the mutual connection thereof.
